(19) United States
(12) Patent Application Publication
(10) Pub. No.: US 2004/0031127 A1
(43) Pub. Date: Feb. 19, 2004

(54) Handle grip structure

(76) Inventor: Sheng-Jen Chen, San-Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,929

(22) Filed: Aug. 13, 2002

(51) Int. Cl. B62B 1/00

(52) U.S. Cl. 16/436

(57) ABSTRACT

A handle grip structure includes an elastic tube, and a slender strip mounted on the elastic tube. The slender strip includes a foamed layer having an inner surface wrapped and bonded around an outer surface of the elastic tube, and a polyester layer coated on an outer surface of the foamed layer. Thus, by provision of the foamed layer having a determined elastic restoring force, the handle grip structure has an excellent shock absorbing effect, thereby decreasing the sport damage applied on the user.

### BACKGROUND OF THE INVENTION

1. Field of the Invention

The present invention relates to a handle grip structure, and more particularly to a handle grip structure, wherein by provision of the foamed layer having a determined elastic restoring force, the handle grip structure has an excellent shock absorbing effect, thereby decreasing the sport damage applied on the user.

2. Description of the Related Art

The closest prior art references of which the applicant is aware are disclosed in the Taiwanese Patent Publication No. 225676; 246845; 248690; 289265; 300457; 314798; 334808; 337182; 339681; 3512205; and 364378. Each of the above-mentioned prior art references disclosed a handle grip made of a weaving layer or a felt layer. However, the weaving layer or felt layer has a poor elastic restoring force, so that the shock absorbing effect of the conventional handle grip is limited.

The closest prior art references of which the applicant is aware are disclosed in the U.S. Pat. No. 5,571,050; 5,571,051; 5,584,482; 5,618,041; 5,645,501; 5,671,923; 5,695,418; 5,730,669; 5,772,524; 5,785,607; 5,797,813; 5,803,828; 5,813,921; 5,816,933; 5,827,129; 5,816,934; 5,857,929; 5,890,972; 5,895,329; 5,910,054; 5,997,421; and 6,203,308. Each of the above-mentioned prior art references disclosed a handle grip.

### SUMMARY OF THE INVENTION

The present invention has arisen to mitigate and/or obviate the disadvantage of the conventional handle grip.

The primary objective of the present invention is to provide a handle grip structure, wherein by provision of the foamed layer having a determined elastic restoring force, the handle grip structure has an excellent shock absorbing effect, thereby decreasing the sport damage applied on the user.

In accordance with the present invention, there is provided a handle grip structure, comprising:

an elastic tube; and

a slender strip mounted on the elastic tube and including a foamed layer having an inner surface wrapped and bonded around an outer surface of the elastic tube, and a polyester layer coated on an outer surface of the foamed layer.

Further benefits and advantages of the present invention will become apparent after a careful reading of the detailed description with appropriate reference to the accompanying drawings.

### BRIEF DESCRIPTION OF THE DRAWINGS

FIG. 1 is a side plan cross-sectional view of a slender strip of a handle grip structure in accordance with a preferred embodiment of the present invention;

FIG. 2 is a side plan cross-sectional view of the slender strip of the handle grip structure in accordance with the preferred embodiment of the present invention, wherein the slender strip is cut;

FIG. 3 is a side plan cross-sectional view of the slender strip of the handle grip structure in accordance with the preferred embodiment of the present invention, wherein a double-face bonding strap is bonded on the inner surface of the foamed layer;

FIG. 4 is a schematic view of the slender strip of the handle grip structure in accordance with the preferred embodiment of the present invention, wherein the double-face bonding strap is partially stripped;

FIG. 5 is a top plan view of a polyester layer of the slender strip of the handle grip structure in accordance with the preferred embodiment of the present invention;

FIG. 6 is a plan view of an elastic tube of the handle grip structure in accordance with the preferred embodiment of the present invention;

FIG. 7 is a partially cut-away plan cross-sectional view of the elastic tube of the handle grip structure in accordance with the preferred embodiment of the present invention;

FIG. 8 is a plan view of the handle grip structure in accordance with the preferred embodiment of the present invention, wherein the slender strip is partially wrapped around the elastic tube; and

FIG. 8A is a plan view of the handle grip structure in accordance with the preferred embodiment of the present invention, wherein the slender strip is wholly wrapped around the elastic tube.

### DETAILED DESCRIPTION OF THE INVENTION

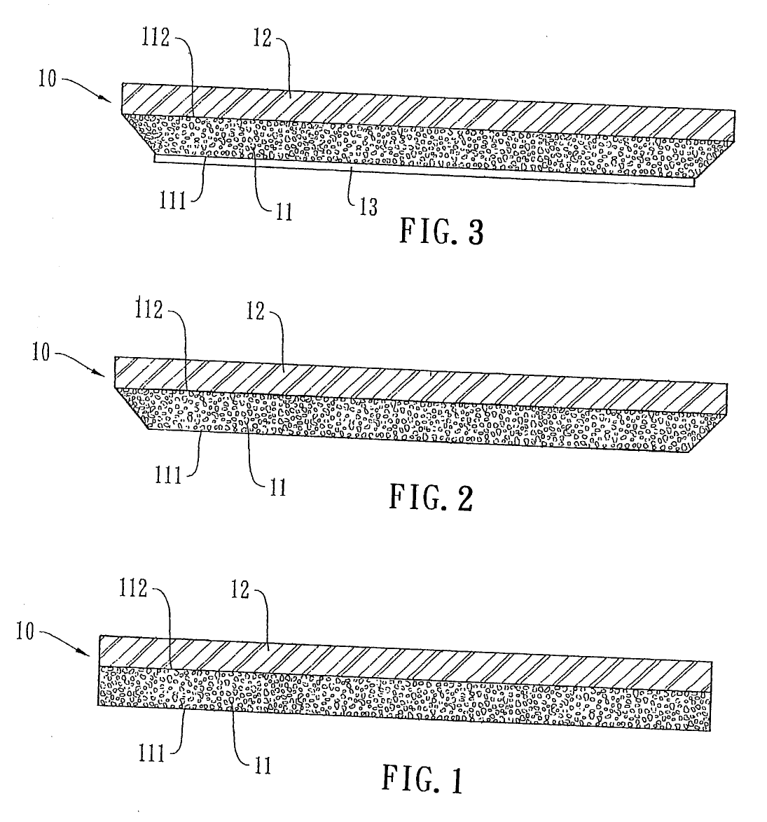

Referring to the drawings and initially to FIG. 1, a handle grip structure in accordance with a preferred embodiment of the present invention is available for a tennis racket handle, a badminton racket handle, a golf club handle or the like, and comprises a slender strip 10. The slender strip 10 includes a foamed layer 11 made of a foamable plastic or foamable rubber, so that the foamed layer 11 has a determined elastic restoring force. The foamed layer 11 of the slender strip 10 has an inner surface 111 and an outer surface 112. The slender strip 10 further includes a polyester (such as a wet type PU) layer 12 coated on the outer surface 112 of the foamed layer 11. The polyester layer 12 is cured in the water, and is then washed, squeezed and dried, thereby forming a PU leather.

As shown in FIG. 2, the two sides of the slender strip 10 are cut.

As shown in FIG. 3, the slender strip 10 further includes a double-face bonding strap 13 bonded on the inner surface 111 of the foamed layer 11.

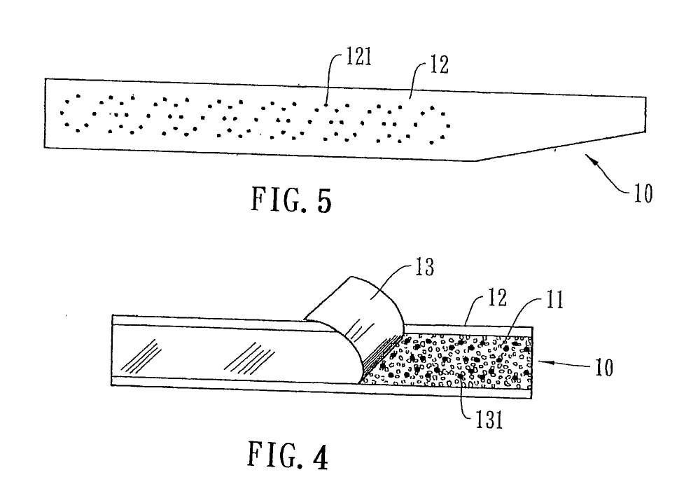

As shown in FIG. 4, the double-face bonding strap 13 may be stripped, thereby exposing the bonding agent 131 of the double-face bonding strap 13, so that the slender strip 10 may be fixed on the tennis racket handle, the badminton racket handle, the golf club handle or the like.

As shown in FIG. 5, the polyester layer 12 of the slender strip 10 has an outer surface formed with a knurl 121, so that the outer surface of the polyester layer 12 of the slender strip 10 has a corrugated shape, thereby increasing the function of the slender strip 10, and thereby preventing the player's hand from slipping on the handle.

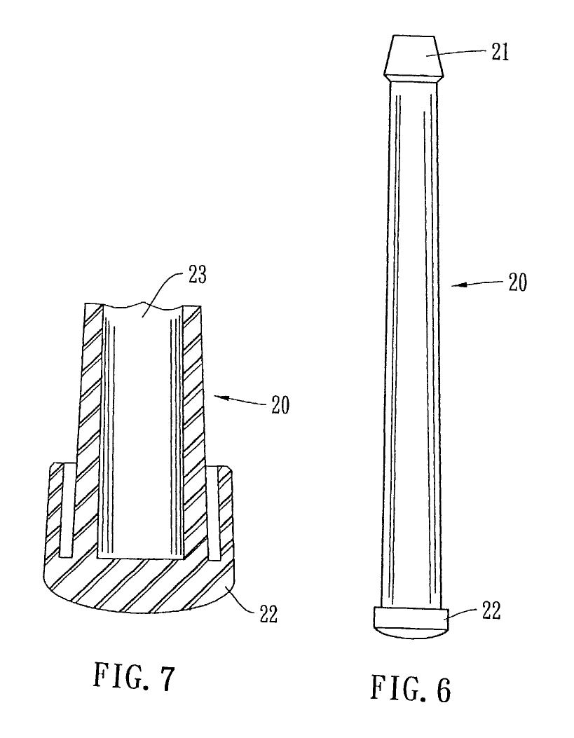

As shown in FIGS. 6 and 7, the handle grip structure in accordance with the preferred embodiment of the present invention further comprises an elastic tube 20. The elastic tube 20 is made of a rubber or a foamable material. The elastic tube 20 has an upper end 21 and a lower end 22. The lower end 22 of the elastic tube 20 is formed with a guide column which has a diameter greater than that of the elastic tube 20. The elastic tube 20 is tapered from the lower end 22 toward the upper end 21. The elastic tube 20 has an inside recessed with a hole 23.

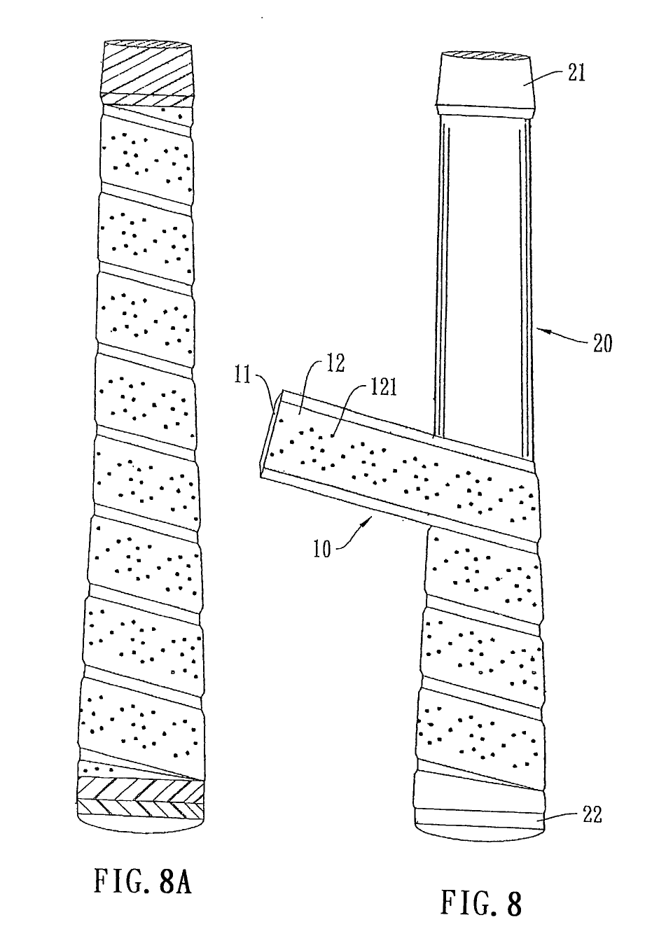

As shown in FIGS. 8 and 8A, the slender strip 10 is wrapped around the elastic tube 20 in a spiral manner, with the bonding agent 131 of the double-face bonding strap 13 being bonded on the outer surface of the elastic tube 20, thereby forming the handle grip structure including the elastic tube 20 and the slender strip 10.

Thus, the handle grip structure in accordance with the preferred embodiment of the present invention uses the foamed layer 11 having a determined elastic restoring force to replace the conventional weaving layer, so that the elastic tube 20 of the present invention has a better shock absorbing effect, thereby decreasing the sport damage applied on the user.

In conclusion, in the handle grip structure in accordance with the preferred embodiment of the present invention, the foamed layer 11 made of a foamable plastic or foamable rubber may be used to replace the non-woven fabric, and the wet type PU layer 12 may be made into a PU leather. The foamed layer 11 made of a foamable plastic or foamable rubber may have an excellent shock absorbing effect, so that the shock absorbing effect of the handle grip structure having the foamed layer 11 made of a foamable plastic or foamable rubber is greater than that of the conventional handle grip structure made of a non-woven material.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A handle grip structure, comprising:
an elastic tube; and
a slender strip mounted on the elastic tube and including a foamed layer having an inner surface wrapped and bonded around an outer surface of the elastic tube, and a polyester layer coated on an outer surface of the foamed layer.

2. The handle grip structure in accordance with claim 1, wherein the elastic tube has an upper end and a lower end, the lower end of the elastic tube is formed with a guide column which has a diameter greater than that of the elastic tube.

3. The handle grip structure in accordance with claim 2, wherein the elastic tube is tapered from the lower end toward the upper end.

4. The handle grip structure in accordance with claim 1, wherein the foamed layer is made of a foamable plastic or foamable rubber.

5. The handle grip structure in accordance with claim 1, wherein the polyester layer of the slender strip has an outer surface formed with a knurl

6. The handle grip structure in accordance with claim 1, wherein the slender strip further includes a double-face bonding strap bonded on the inner surface of the foamed layer and bonded on the outer surface of the elastic tube.

7. The handle grip structure in accordance with claim 1, wherein the elastic tube has an inside recessed with a hole.
